(19) United States
(12) Patent Application Publication
(10) Pub. No.: US 2025/0278590 A1
(43) Pub. Date: Sep. 4, 2025

(54) Bar-code printing device, method and computer program product for printing bar-codes

(71) Applicant: VMI Holland B.V., Epe (NL)

(72) Inventor: Patrick van Voorn, Epe (NL)

(73) Assignee: VMI Holland B.V., Epe (NL)

(21) Appl. No.: 18/858,762

(22) PCT Filed: May 10, 2023
(86) PCT No.: PCT/EP2023/062445

§ 371 Date: Oct. 22, 2024

(30) Foreign Application Priority Data
May 12, 2022 (NL) 2031838

(51) Int. Cl. G06K 15/02; G06K 5/02

(52) U.S. Cl. CPC G06K 15/027; G06K 5/02

(57) ABSTRACT

A bar-code printing device, a method and a computer program product for printing bar-codes is provided, wherein the bar-code printing device includes a printer that defines a printable area for printing bar-codes on a substrate and a scanner for scanning the bar-codes printed on the substrate, wherein the bar-code printing device is provided with a control unit that is operationally connected to the printer and the scanner and configured for performing the following steps: a) instructing the printer to print the bar-codes on the substrate in different bar-code positions within the printable area; b) obtaining scans of the bar-codes printed on the substrate from the scanner; and c) comparing the bar-code in each scan with information about the respective bar-code at least until a discrepancy is identified.

### BACKGROUND

The invention relates to a bar-code printing device and a method for printing bar-codes.

FR 2 682 512 A1 discloses a process for the automatic prevention of printing defects in bar-codes in a printer whose printing head includes a multiplicity of juxtaposed dot-printing members liable to be individually defective. Prior to printing, an electronic circuit is used to detect the state of the micro-resistors of the print head, which states are stored in a control data table. Subsequently, successive positions of a bar-code are virtually compared with respect to the positions of the defective printing members, for the purpose of determining a laterally offset position of the bar-code in which none of the defective printing members are being used to print one of the bars of the bar-code. This process allows the printing of a bar code, shifted to the right or to the left, using only the micro-resistors that are in good working order for printing of the bars.

### SUMMARY OF THE INVENTION

A disadvantage of the known bar-code printer and process is that it merely attempts to shift the bar-code to avoid the defective dot-printing members and successfully print the bar-code despite the defective dot-printing members. This may be acceptable for most bar-code applications where having a readable bar-code is the only critical requirement. However, in the field of printing labels, pouches or other substrates with pharmaceutical information, the bar-code printer is not only used to print a bar-code, but also human-readable, patient-related information critical for the patient. Although the shifted bar-code may still be readable, the defective dot-printing members can still cause blank lines in the critical patient information.

Moreover, the electronic circuit for detecting the defective dot-printing members may not be able to reliably identify all types of defects, for example defects relating to pollution or the absence of a substrate to print the bar-code on.

Finally, the available printing area may be limited and/or the layout or design of the information to be printed does not always allow for dedicated printer verification patterns to be printed.

It is an object of the present invention to provide a bar-code printing device, method and computer program product for printing bar-codes, wherein the quality of the information printed by the bar-code printing device can be determined and/or improved.

According to a first aspect a bar-code printing device is provided comprising a printer that defines a printable area for printing bar-codes on a substrate and a scanner for scanning the bar-codes printed on the substrate, wherein the bar-code printing device is provided with a control unit that is operationally connected to the printer and the scanner and configured for performing the following steps:
a) instructing the printer to print the bar-codes on the substrate in different bar-code positions within the printable area;
b) obtaining scans of the bar-codes printed on the substrate from the scanner; and
c) comparing the bar-code in each scan with information about the respective bar-code at least until a discrepancy is identified.

By printing the bar-codes in different bar-code positions, different sections of the printable area will be used over time to receive bars of the bar-code. Therefore, a small malfunction in the printer that occurs locally at a specific position within the printable area is more likely to be discovered early, e.g. after printing a limited number of bar-codes in various bar-code positions. By scanning the bar-codes and comparing the scans with the information stored about said bar-codes, malfunctions can be determined or identified that would not be detectable by means that only analyze the state of the printer.

Moreover, rather than avoiding the malfunction, which could negatively affect the readability of other information printed with the same printer, appropriate action can be taken to repair the malfunction as soon as possible. Hence, the overall print quality can be improved, not only for the bar-codes but also for other information printed by the same printer, such as critical, human-readable patient information.

Also, by using the bar-codes themselves as verification for the print quality, no separate or dedicated verification patterns are required within the printable area.

In one embodiment the bar-code printing device further comprises a database unit for storing information about the bar-codes printed on the substrate, wherein the control unit is operationally connected to the database unit for comparing the bar-code in each scan with the information stored in the database unit about the respective bar-code. The database unit can be configured to store information about multiple barcodes in a structured manner. The database unit can be a separate unit, or part of the control unit, for example a database-like structure in a memory integrated in said control unit.

In one embodiment the control unit is configured for interrupting the printing of bar-codes when the discrepancy is identified. Hence, it can be prevented that any further bar-codes and related human-readable information is printed until the malfunction is repaired.

In another embodiment the control unit is configured for generating a notification that the discrepancy is identified. The notification can point an operator to the malfunction and aid its repair. The notification may for example visualize the location of the malfunction in the scan of the respective bar-code or identify a location of the malfunction in the printer.

In another embodiment the printer comprises a printer head with an array of printing members juxtaposed in a lateral direction to define a width of the printable area, wherein the bar-code positions are shifted in said lateral direction. Hence, different printing members within the array are used for printing a series of the bar-codes.

In a further embodiment the control unit is configured for shifting the bar-code positions to use all print members of the array of printing members at least once during a specific bar-code print count, i.e. the number of bar-codes that have been printed. In particular the specific bar-code print count is chosen to be equal to or less than one-hundred, and preferably equal to or less than ten. Hence, a local malfunction of one or more of the printing members can be detected as early as possible, e.g. within ten printed bar-codes or less. The bar-code positions may be shifted incrementally and/or in the same direction. The control unit may also determine or predict overlap between the individual bars of subsequent bar-codes in the lateral direction and calculate the direction and magnitude of the shifts necessary to address all printing members with the least amount of bar-codes. The shifts may thus be different in magnitude and/or direction to use all printing members within the least amount of printed bar-codes.

In a further embodiment the control unit is configured for identifying a malfunctioning printing member within the array of printing members responsible for the discrepancy based on the position of said discrepancy in the respective scan. Hence, rather than relying on means to detect the state of the individual printing members, the location of the discrepancy detected in the respective scan can be used to associate said position with the printing member that is causing said discrepancy, for example by comparing the lateral position of the discrepancy within the printable area with the known lateral positions of the printing members relative to said printable area.

In a further embodiment each printing member of the array of printing members comprises one of a thermal printing member, an ink printing member, a toner printing member, a resistor or a nozzle. The bar-code printing device may thus detect discrepancies as a results of malfunctions at the printer, specific to the printing members listed above, for 15 example a defective resistor, a clogged nozzle and/or pollution.

In another embodiment the printer is arranged for outputting a string of pouches, wherein the substrate is formed by the string and each pouch is provided with one bar-code. The bar-code printing member can thus prevent that the printer continues to print a string of pouches after a discrepancy has been detected that could affect the readability of the information that is printed on said pouches.

In another embodiment the control unit comprises a processor and a non-transitory computer-readable medium holding instructions that, when executed by the processor, cause the control unit to perform the steps a), b) and c). In other words, the control unit can be adapted, configured and/or programmed to perform the aforementioned steps with the use of software loaded onto the non-transitory computer-readable medium.

According to a second aspect a method is provided for printing bar-codes on a substrate, wherein the method comprises the following steps:
a) instructing a printer to print the bar-codes on the substrate in different bar-code positions within a printable area; and
b) comparing each bar-code with information about the respective bar-code at least until a discrepancy is identified.

The method relates to the practical implementation of the bar-code printing device and thus has the same technical advantages, which will not be repeated hereafter.

In one embodiment the printing of bar-codes is interrupted when the discrepancy is identified.

In another embodiment a notification is generated that the discrepancy is identified.

In another embodiment the printer comprises a printer head with an array of printing members juxtaposed in a lateral direction to define a width of the printable area, wherein the bar-code positions are shifted in said lateral direction.

In a further embodiment the bar-code positions are shifted such that all print members of the array of printing members are used at least once during a specific bar-code print count. In particular, the specific bar-code print count is chosen to be equal to or less than one-hundred, and preferably equal to or less than ten.

In a further embodiment a malfunctioning printing member within the array printing members that is of responsible for the discrepancy is identified based on the position of said discrepancy in the printable area.

In another embodiment the printer outputs a string of pouches, wherein the substrate is formed by the string and each pouch is provided with one bar-code.

According to a third aspect a computer program product is provided comprising a non-transitory computer-readable medium holding instructions that, when executed by a processor, cause a control unit of a bar-code printing device according to any one of the embodiments of the first aspect to perform the steps of the method according to any one of the embodiments of the second aspect.

In other words, the control unit can be adapted, configured and/or programmed to perform the aforementioned steps with the use of software loaded onto the non-transitory computer-readable medium.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a perspective view of a bar-code printing device comprising a printer that produces a string of pouches, a scanner and a control unit according to an exemplary embodiment of the invention;

FIG. 2 shows a top view of one of the pouches printed with the printer of FIG. 1 when said printer is functioning properly;

FIG. 3 shows a top view of said one pouch printed with the printer of FIG. 1 when said printer is malfunctioning; and

FIG. 4 shows a top view of another one of the pouches printed with the printer of FIG. 1 when said printer is malfunctioning.

### DETAILED DESCRIPTION OF THE INVENTION

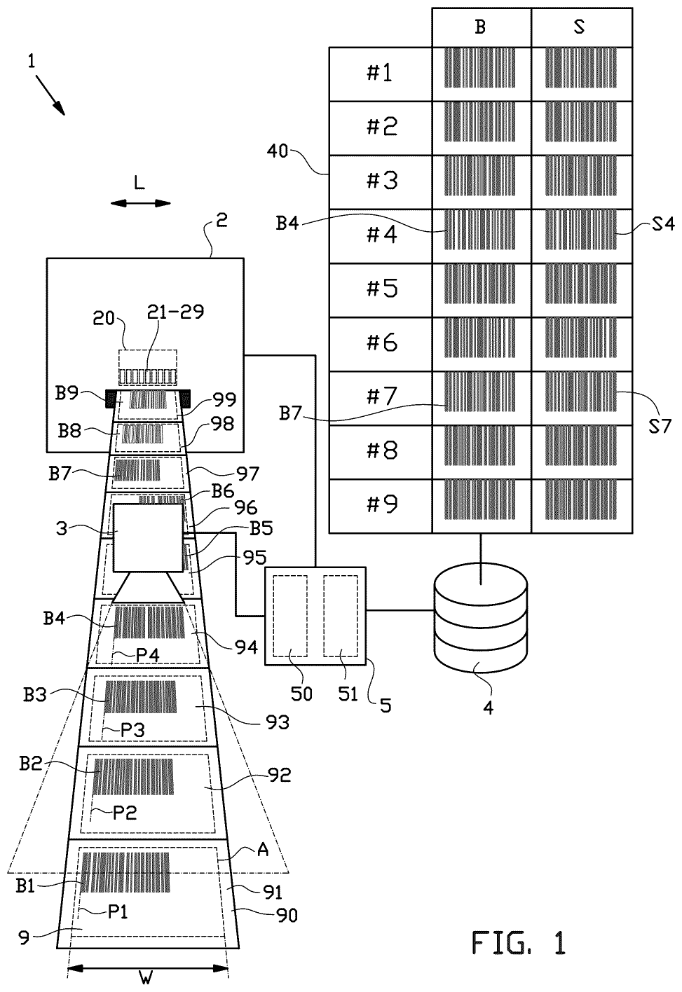

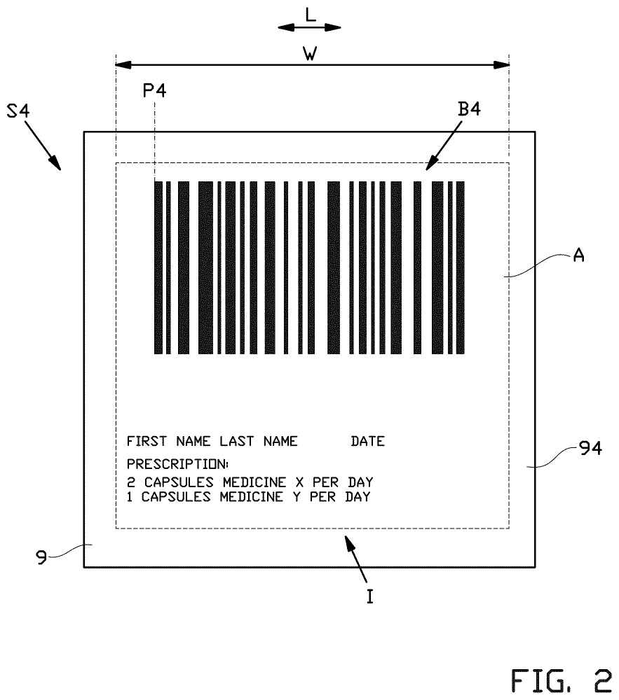

FIG. 1 shows a bar-code printing device 1 for printing bar-codes B1-B9 on a substrate 9. In this example, the substrate 9 is formed by or is a string 90 of pouches 91-99, 99, in particular pouches 91-99 for receiving discrete medicaments (not shown) for the pharmaceutical industry. Each pouch 91-99 is provided with one bar-code B1-B9 unique to said pouch 91-99. Note that due to the schematic nature of FIGS. 1-4, not every bar-code B1-B9 that is shown is unique, while in practice, they typically would be. Furthermore, as shown in FIGS. 2-4, each pouch 91-99 is further provided with human-readable, patient-related information I critical for the patient.

Alternatively, the substrate 9 can be formed by a label, a sticker or the surface of an object, such as a vial or a tablet case.

As shown in FIG. 1, the bar-code printing device 1 comprises a printer 2, a scanner 3, a database unit 4 and a control unit 5. The control unit is operationally and/or electronically connected to the printer 2, the scanner 3 and the database unit 4.

The printer 2 comprises a printer head 20 that defines a printable area A for printing the bar-codes B1-B9 on the substrate 9. More in particular, the printer head 20 is provided with a row or an array of printing members 21-29 that are side-by-side, adjacent or juxtaposed in a lateral direction L. In FIG. 1, nine printing members 21-29 are shown, while in practice there may be considerably more printing members, for example more than one-hundred or more than two-hundred-and-fifty. The array of printing members 21-29 defines a width W of the printable area A. The printer head 20 is fixed such that the printable area A remains stationary or substantially stationary relative to the substrate 9 in the lateral direction L.

The printing members 21-29 may be thermal printing members, ink printing members, toner printing members or the like. The printing members 21-29 may comprises resistors, micro-resistors or nozzles.

The scanner 3 comprises sensing or imaging means, for example a camera, for obtaining an optical image or a scan S1-S9 of the bar-codes B1-B9. Alternatively, a scan line is projected onto said bar-codes B1-B9 by a scan line emitter (not shown), for example a laser, in which case the scan S1-S9 may just be a single line instead of an image. In the situation as shown in FIG. 1, the scanner 3 is positioned at a distance downstream of the printer 2. Ideally, the scanner 3 is positioned downstream yet as close as possible to the printer 2 so that any errors can be detected early. The database unit 4 is configured to store information about the bar-codes: B1-B9 printed on the substrate 9 and/or scans S1-S9 received from the scanner 3 in a table or a cross reference table 40. As schematically shown in FIG. 1, the table 40 may have a first column that holds a sequence number (#1-#9), for example the order in which the bar-codes B1-B9 were printed, such that it can be referenced for later use. A second column, in this example marked ‘B’, stores the information on the bar-codes B1-B9. A third column, in this example marked ‘S’, stores the scans S1-S9. The information about the bar-codes B1-B9 may comprise a visual representation of the bar-codes B1-B9 to be printed, the information represented by said bar-code B1-B9, the print instructions that were sent to the printer 2 to print the respective bar-code B1-B9 and/or a visual representation of the bar-code B1-B9 that should have been printed based on said print instructions.

It will be understood that the information discussed above can be presented in many different forms, not limited to the columns and the table 40 as shown. The information is not necessarily presented graphically to an operator. Instead, the process of storing, retrieving, comparing, analyzing and controlling in response to the analysis may be performed internally without any visual display.

The control unit 5 comprises a processor 50 and a non-transitory computer-readable medium 51. The computer-readable medium 51 is non-transitory or tangible, e.g. a physical data carrier such as a hard-drive, a USB-drive, a RAM memory or the like. The computer-readable medium 51 is configured to received and/or hold instructions that, when executed by the processor 50, cause the control unit 5 to control the bar-code printing device 1 in a manner that will be described hereafter in more detail. As such, the computer-readable medium 51 can be considered as a part of a computer program product comprising said non-transitory computer-readable medium 51.

A method for printing the bar-codes B1-B9 on the substrate 9 will now be elucidated with reference to FIGS. 1-4.

FIG. 1 shows the situation in which the control unit 5 has sent instructions to the printer 2 to print the bar-codes B1-B9 on the substrate 9, in this example the string 90 of pouches 91-99. Specifically, the control unit 5 has instructed the printer 2 to print the bar-codes B1-B9 in different bar-code positions P1-P9 within the printable area A. The bar-code positions P1-P9 are shifted in the lateral direction L so that different printing members 21-29 are active, operated and/or used over time to print the bar-codes

B1-B9 in the different bar-code positions P1-P9. The print instructions that were sent to the printer 2 to print the respective bar-code B1-B9 and/or a visual representation of the bar-code B1-B9 that should have been printed based on said print instructions is stored in the database unit 4, in particular in column ‘B’ of the table 40, and linked to or associated with a sequence number #1-#9 in the same table 40. FIG. 1 further shows that the scanner 3 is used to obtain scans S1-S9 of the bar-codes B1-B9 that have been printed on the substrate 9. The scans S1-S9 are stored in the database unit 4, in particular in column ‘S’ of the table 40, and linked to or associated with a sequence number #1-#9 in the same table 40.

As shown in FIGS. 2-4, for each combination of a bar-code B1-B9 and a scan S1-S9, the control unit 5 is configured to compare the bar-code B1-B9 in each scan S1-S9 with the information stored in the database unit 4 about the respective bar-code B1-B9. In particular, the control unit 5 is configured for detecting discrepancies between the information stored in the database unit 4 about the respective bar-code B1-B9 and the bar-code B1-B9 as actually printed and scanned.

FIG. 2 shows a scan S4 of a pouch 94 with a bar-code B4 that is printed in a bar-code position P4 with a printer 2 that is functioning properly. Hence, the bar-code B4 is printed completely without any errors. The same applies to the patient information I printed in the printable area A below the bar-code B4.

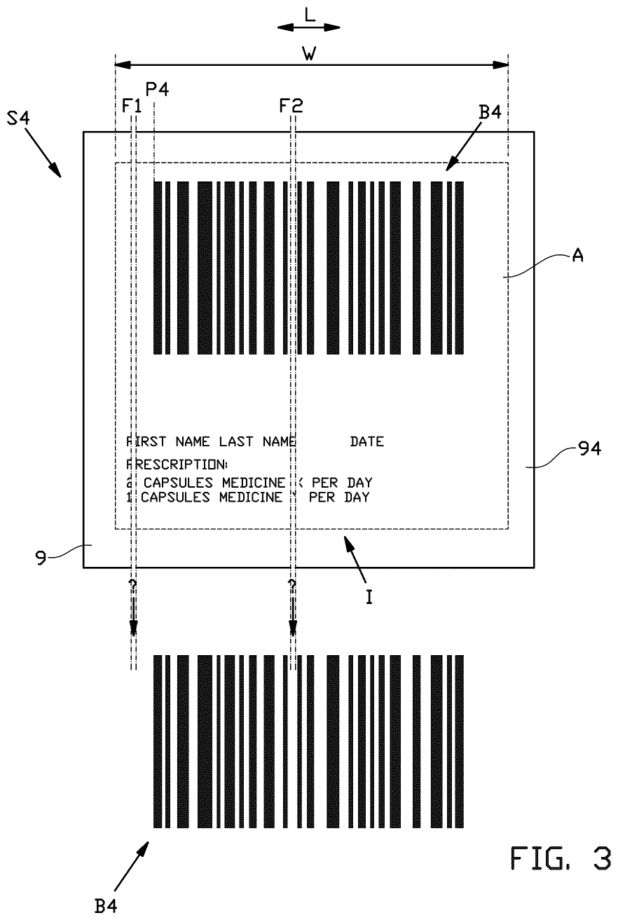

FIG. 3 shows, for the purpose of comparison, the same scan S4 with the same bar-code B4, yet printed with a printer 2 that is malfunctioning. In particular, the printer head 20 has two faulty or defective printing members (not shown) which cause two faulty lines or blank lines F1, F2 to appear in the printable area A. Note that the first blank line F1 does not pass through the bar-code B4 at all and the second blank line F2 passes through a part of the bar-code B4 that is not or only partially occupied by the bars of said bar-code B4. Hence, the comparison with the bar-code information associated with the bar-code B4 in the table 40 of the database unit 4, schematically shown in FIG. 3 below the pouch 94, does not result in any discrepancies being identified. The inability to detect the blank lines F1, F2 is reflected schematically with the question marks pointing to the areas of within and outside the bar-code B4 that are affected. Despite the bar-code B4 being printed in a manner that does not result in a discrepancy being detected, the blank lines F1, F2 overlap with critical parts of the patient information I below the bar-code B4. In particular, the amount of capsules to be taken and the frequency of taking said capsules is unreadable.

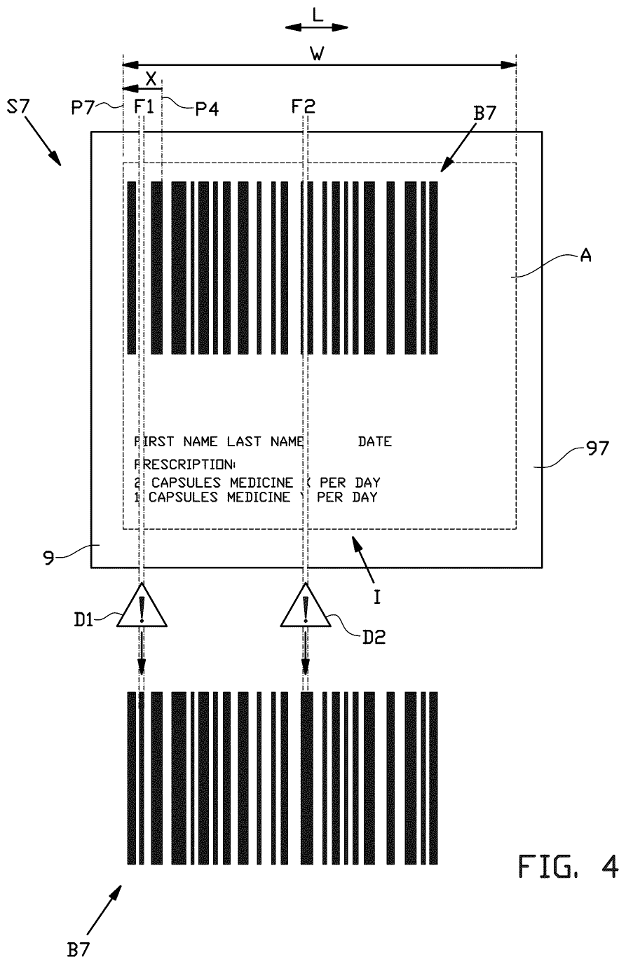

FIG. 4 shows a scan of another bar-code B7 that is printed after the printing of the bar-code B4 in FIG. 3, with the same malfunctioning printer 2 having the two faulty or blank lines F1, F2 in the same position within the printable area A. However, the bar-code B7 in FIG. 4 is shifted with respect to the bar-code B4 in FIG. 3 over a shift X from the bar-code position P4 of FIG. 3 to the bar-code position P7 in FIG. 4. The shift X in FIG. 4 may be the result or accumulation of an incremental shift in the bar-code positions P1-P9 for each subsequent bar-code B1-B9 that is being printed. Alternatively, the control unit 5 may determine or predict overlap between the individual bars of subsequent bar-codes B1-B9 in the lateral direction L and calculate the direction and magnitude of the shifts X necessary to address all printing members 21-29 with the least amount of bar-codes B1-B9. The shifts X may thus be different in magnitude and/or direction.

The bar-code positions P1-P9 are shifted such that, within a specific bar-code count, for example with every ten bar-codes B1-B9 or less, all printing members 21-29 of the array of printing members 21-29 have been used at least once for printing of the bar-codes B1-B9. In this example, the bar-codes B1-B9 are shifted incrementally in one direction over six steps across the entire width W of the printable area A and then the process is repeated.

The bar-code B7 that is printed, as shown in the scan S7 in FIG. 4, is compared by the control unit 5 with the information associated with said bar-code B7 in the table 40 of the database unit 4, schematically shown in FIG. 4 below the pouch 97. Because of the shifted bar-code position P7, the blank lines F1, F2 now overlap with bars of the bar-code B7, thereby resulting in two clearly identifiable differences or discrepancies D1, D2 between the bar-code B7 in the scan S7 and the information associated with said bar-code B7, as schematically shown with the exclamation marks in FIG. 4.

The control unit 5 is configured to take appropriate action when detecting a discrepancy D1, D2. Such an action may be to perform an automated cleaning job at the printer head 20, to instruct the printer 2 to perform a self-diagnostic and/or to interrupt the printing. Additionally or alternatively, the control unit 5 may be configured to send a notification, for example a graphical notification or an audible alarm. The control unit 5 may further be configured for identifying the printing member(s) 21-29 within the array of printing members 21-29 responsible for the discrepancy D1, D2 based on the position of said discrepancy D1, D2 within the respective scan S1-S9. The operator can subsequently repair the malfunction, after which the printing can be resumed.

The pouches 91-99 that have already been printed prior to identifying the discrepancy may be taken out of the process and can be reproduced when the malfunction has been repaired.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 bar-code printing device

2 printer

20 printer head

21-29 printing members

3 scanner

4 database unit

40 table

5 control unit

50 processor

51 computer-readable non-transitory memory

9 substrate

90 string

91-99 pouches

A printable area

B1-B9 bar-codes

D1, D2 discrepancies

F1, F2 faulty print line

I patient information

L lateral direction

P1-P9 bar-code positions

S1-S9 scans

X shift

W width

1. Bar-code printing device comprising a printer comprising a printer head with an array of printing members that defines a printable area for printing bar-codes on a substrate and a scanner for scanning the bar-codes printed on the substrate, wherein the bar-code printing device is provided with a control unit that is operationally connected to the printer and the scanner and configured for performing the following steps:
a) instructing the printer to print the bar-codes on the substrate in different bar-code positions within the printable area for a specific bar-code print count, wherein the control unit is configured for shifting the bar-code positions such that within the specific bar-code print count all printing members of the array of printing members have been used at least once for printing of the bar codes;
b) obtaining scans of the bar-codes printed on the substrate from the scanner; and
c) comparing the bar-code in each scan with information about the respective bar-code at least until a discrepancy is identified count.

2. Bar-code printing device according to claim 1, wherein the bar-code printing device further comprises a database unit for storing information about the bar-codes printed on the substrate , wherein the control unit is operationally connected to the database unit for comparing the bar-code in each scan with the information stored in the database unit about the respective bar-code.

3. Bar-code printing device according to claim 1, wherein the control unit is configured for interrupting the printing of bar-codes when the discrepancy is identified.

4. Bar-code printing device according to claim 1, wherein the control unit is configured for generating a notification that the discrepancy is identified.

5. Bar-code printing device according to claim 1, wherein the array of printing members is juxtaposed in a lateral direction to define a width of the printable area, wherein the bar-code positions are shifted in said lateral direction.

6. Bar-code printing device according to claim 1, wherein the specific bar-code print count is chosen to be equal to or less than one-hundred.

7. Bar-code printing device according to claim 1, wherein the control unit is configured for identifying a malfunctioning printing member within the array of printing members responsible for the discrepancy based on the position of said discrepancy in the respective scan.

8. Bar-code printing device according to claim 1, wherein each printing member of the array of printing members comprises one of a thermal printing member, an ink printing member, a toner printing member, a resistor or a nozzle.

9. Bar-code printing device according to claim 1, wherein the printer is arranged for outputting a string of pouches, wherein the substrate is formed by the string and each pouch is provided with one bar-code.

10. Bar-code printing device according to claim 1, wherein the control unit comprises a processor and a non-transitory computer-readable medium holding instructions that, when executed by the processor, cause the control unit to perform the steps a), b) and c).

11. Method for printing bar-codes on a substrate, wherein the method comprises the following steps:
a) instructing a printer to print the bar-codes on the substrate in different bar-code positions within a printable area for a specific bar-code print count, wherein the printer comprises a printer head with an array of printing members, and wherein the control unit is configured for shifting the bar-code positions such that within the specific bar-code print count all printing members of the array of printing members have been used at least once for printing of the bar codes; and
b) comparing each bar-code with information about the respective bar-code at least until a discrepancy is identified.

12. Method according to claim 11, wherein the printing of bar-codes is interrupted when the discrepancy is identified.

13. Method according to claim 11, wherein a notification is generated that the discrepancy is identified.

14. Method according to claim 11, wherein the array of printing members is juxtaposed in a lateral direction to define a width of the printable area, wherein the bar-code positions are shifted in said lateral direction.

15. Method according to claim 11, wherein the specific bar-code print count is chosen to be equal to or less than one-hundred.

16. Method according to claim 11, wherein a malfunctioning printing member within the array of printing members that is responsible for the discrepancy is identified based on the position of said discrepancy in the printable area.

17. Method according to claim 11, wherein the printer outputs a string of pouches, wherein the substrate is formed by the string and each pouch is provided with one bar-code.

18. Computer program product comprising a non-transitory computer-readable medium holding instructions that, when executed by a processor, cause a control unit of a bar-code printing device to perform the steps of the method according to claim 11.
